(19) United States
(12) Patent Application Publication
(10) Pub. No.: US 2025/0205618 A1
(43) Pub. Date: Jun. 26, 2025

(54) SEPARATING APPARATUS, FEED DEVICE, AND METHOD FOR PURIFYING A LIQUID

(71) Applicant: ACO AHLMANN SE & CO. KG, Budelsdorf (DE)

(72) Inventors: Teresa FENZEL, Biblis (DE); Moritz GESTERDING, Bensheim (DE); Alexander PASING, Lampertheim (DE)

(21) Appl. No.: 18/846,793

(22) PCT Filed: Mar. 15, 2023
(86) PCT No.: PCT/EP2023/056608

§ 371 Date: Sep. 13, 2024

(30) Foreign Application Priority Data
Mar. 16, 2022 (DE) 10 2022 106 144.2

(51) Int. Cl. B01D 21/24; B01D 21/00

(52) U.S. Cl. CPC B01D 21/2416; B01D 21/0012; B01D 21/0042; B01D 2221/12

(57) ABSTRACT

A separating apparatus for purifying a liquid such as purifying rainwater. The apparatus includes a container having at least one separating area and a settling and sludge collection chamber, wherein the settling and sludge collection chamber is fluidically connected to the separating area for receiving sediments to be separated and at least one feed device for feeding the liquid to be purified having at least one liquid outlet opening into the separating area, wherein the feed device has a lower guide plate arranged during use below the liquid outlet such that a liquid flowing out of the liquid outlet is guided radially outwards through the lower guide plate in the direction of the inner wall of the container, wherein a lower gap is formed between the outer circumference of the lower guide plate and the inner wall of the container.

The invention relates to a separating apparatus for purifying a liquid, in particular for purifying rainwater, according to the preamble of claim 1. In addition, the invention relates to a feed device for such a separating apparatus and a method for purifying a liquid using such a separating apparatus. A separating apparatus of the type mentioned above is known, for example, from KR 10 0795918 B1.

Separating apparatuses are usually used in rainwater treatment plants and are used to purify rainwater, in particular to separate contaminants from rainwater due to differences in density. For this purpose, a liquid to be purified flows through a container, wherein the liquid separates sediments in the container. For a high sedimentation effect in the container, the inflowing liquid to be purified is to be distributed as evenly as possible and remobilization of sediments already separated is to be avoided as much as possible.

KR 100795918 B1 describes a separation apparatus for purifying rainwater comprising an feed device for a liquid to be purified having a central outlet opening directed downward. A funnel-shaped collecting apron is provided under the outlet opening, which collects sediments separated during use and directs them into a sediment basin arranged underneath. The disadvantage of this separating apparatus is the increased turbulence of the sediments collected on the collecting apron due to the liquid to be purified flowing downward. In addition, such a separation principle is difficult to combine with filtration and adsorption.

It is therefore the object of the present invention to improve a separating apparatus of the type mentioned at the outset in such a way that the remobilization of separated sediments is reduced and the structure is simplified. Furthermore, it is an object of the present invention to provide a feed device and a method for purifying a liquid.

This object is achieved according to the invention by a separating apparatus according to claim 1. The object is achieved with regard to the feed device by the subject matter of claim 13 and with regard to the method for purifying a liquid by the subject matter of claim 14.

Specifically, the object is achieved according to the invention by a separating apparatus for purifying a liquid, in particular for purifying rainwater, comprising a container with at least one separating area and a settling and sludge collection chamber. The settling and sludge collection chamber is fluidically connected to the separating area to receive sediments to be separated and is arranged below the separating area during use. The separating apparatus comprises at least one feed device for feeding the liquid to be purified having at least one liquid outlet which opens into the separating area. The feed device has at least one lower guide plate between the settling and sludge collection chamber and the separating area, wherein the lower guide plate is arranged during use below the liquid outlet such that a liquid flowing out of the liquid outlet can be guided radially outwards through the lower guide plate in the direction of the inner wall of the container. A lower gap is formed between the outer circumference of the lower guide plate and the inner wall of the container.

The separated sediments are collected in the settling and sludge collection chamber. The separation of sediments from the liquid occurs by gravity. The sediments sink in the liquid. The settling and sludge collection chamber can also be called a sludge trap.

During use, the separating area is arranged in the direction of gravity above the settling and sludge collection chamber and is used to feed the liquid to be purified. In addition, the liquid in the separating area can be treated for further purification.

The invention has the advantage that the lower guide plate both promotes a uniform distribution of the inflowing liquid to be purified and reduces remobilization of sediments that have already been separated.

In use, the lower guide plate directs a liquid flowing from the liquid outlet radially outward towards the inner wall of the container. This ensures that the liquid to be purified is evenly distributed. The lower gap between the outer circumference of the lower guide plate and the inner wall of the container allows sediments to be separated to subsequently sink into the settling and sludge collection chamber. Since the lower guide plate is arranged below the outlet opening and between the separating area and the settling and sludge collection chamber, the settling and sludge collection chamber is largely shielded from currents in the separating area, which reduces remobilization of sediments already separated in the settling and sludge collection chamber.

The present invention therefore takes a different approach than the prior art, which provides separate structural measures for distributing the liquid to be purified and for preventing remobilization of sediments that have already been separated. Rather, in a separating apparatus according to the invention, these two tasks are coupled within one element, namely the lower guide plate. This functional coupling has the further advantage that a separating apparatus according to the invention is constructed more simply in comparison to the prior art, whereby the weight, size, maintenance effort, and susceptibility to errors of a separating apparatus can be reduced.

A separating apparatus according to the invention is designed for use in rainwater treatment plants, in particular in sedimentation plants for rainwater treatment. It is also possible to use the concept according to the invention in other separators, for example in light liquid separators or in grease separators. Furthermore, the invention can be used generally in connection with plants for treating a liquid.

The settling and sludge collection chamber is fluidically connected to the separating area by the lower gap to receive sediments to be separated. The lower gap can be formed as a circumferential gap between the outer circumference of the lower guide plate and the inner wall of the container. The lower gap can be formed as a radial gap between the outer circumference of the lower guide plate and the inner wall of the container. In particular, the lower gap can be formed as a radial circumferential gap between the outer circumference of the lower guide plate and the inner wall of the container. In other words, the lower gap can be formed as an annular gap between the outer circumference of the lower guide plate and the inner wall of the container. The lower gap can also have a different shape. For example, the shape of the lower gap can have corners, edges, and/or roundings. It is also possible for the lower gap to be designed to be circumferential in sections. In other words, the lower gap can be interrupted in sections.

In a preferred embodiment of the invention, the feed device has an upper guide plate, which is arranged above the lower guide plate in use. The upper guide plate and the lower guide plate form an intermediate space into which the liquid outlet opens in such a way that a liquid flowing out of the liquid outlet into the intermediate space can be guided radially outwards through both guide plates. The intermediate space therefore channels the liquid to be purified from the liquid outlet radially outward in the direction of the inner wall of the container, which additionally promotes an even distribution of the liquid to be purified, in particular in the radial direction. It is preferred if the liquid outlet is arranged between the lower guide plate and the upper guide plate.

In a preferred embodiment of the invention, it is provided that the area of the lower guide plate substantially corresponds to or is greater than the area of the upper guide plate. In particular, the two guide plates can be designed in such a way that, in a top view, the outer circumference of the lower guide plate encloses the outer circumference of the upper guide plate. In other words, the outer circumference of the lower guide plate can have a smaller distance to the inner wall of the container than the outer circumference of the upper guide plate. Such a design of the two guide plates promotes, during use, a deflection of a liquid to be purified flowing out of the intermediate space away from the settling and sludge collection chamber upwards. Conversely, this increases the shielding effect of the lower guide plate with regard to the settling and sludge collection chamber, thus further reducing remobilization of separated sediments in the settling and sludge collection chamber. The area of the lower guide plate can also be smaller than the area of the upper guide plate.

In a further preferred embodiment of the invention, it is provided that the entire opening area of the liquid outlet substantially corresponds to or is greater than the smallest inner cross-sectional area of the feed device through which flow can occur. In this way, acceleration of the liquid to be purified due to a cross-sectional tapering at the liquid outlet is avoided during use, thereby reducing flow-inhibiting turbulence between the accelerated liquid to be purified and the liquid already present. Such a design of the liquid outlet therefore promotes an even distribution of the liquid to be purified.

It is preferably provided that the liquid outlet has multiple lateral outlet openings. This divides the entire opening area of the liquid outlet into multiple smaller opening areas corresponding to the outlet openings. The spatial distribution of the entire opening area of the liquid outlet created in this way ensures a particularly even distribution of the liquid to be purified in the container. The lateral arrangement of the outlet openings also assists distribution of a liquid to be purified in a radial direction. The lateral outlet openings are preferably arranged laterally in relation to a longitudinal direction of the feed device. In other words, the lateral outlet openings are preferably arranged on an outer side of the feed device.

To improve the distribution of the liquid to be purified, the lateral outlet openings are preferably arranged distributed in the circumferential direction of the feed device, in particular evenly distributed. The lateral outlet openings can also be arranged unevenly distributed in the circumferential direction of the feed device, for example in order to deliberately direct the liquid to be purified in one or more directions.

It is further preferred that the feed device has at least one support foot which is arranged on the lower guide plate and, in use, supports the feed device on a bottom of the container for relief. Particularly preferably, the feed device has three support feet.

The lower guide plate preferably has a passage opening which is closable by means of an actuating apparatus which can be led through the feed device. The passage opening connects the settling and sludge collection chamber to the interior of the feed device in such a way that separated sediments are removable from the settling and sludge collection chamber through the interior of the feed device. The closable passage opening in the lower guide plate allows easy access in use to the settling and sludge collection room from above without having to remove fittings arranged in the container.

Preferably, at least one treatment stage, in particular a substrate filter stage, is arranged above the lower guide plate. During use, a rising, low-sediment liquid flows through the treatment stage, wherein contaminants, in particular dissolved and finely distributed contaminants, such as heavy metals or filterable substances, are additionally removed. The purifying effect of the separating apparatus is enhanced in this way.

The treatment stage particularly preferably comprises removable segments. This simplifies handling when installing and/or removing the treatment stage, for example. In the case of a circular container, the segments are circular segments. For other container cross sections, the segments are adapted accordingly.

The treatment stage is also preferably adjustable in its height. In other words, the height of the treatment stage can be used to adjust the distance that a rising liquid travels within the treatment stage. This makes it possible, for example, to calibrate or adjust the purifying effect of the separating apparatus.

In a preferred embodiment of the invention, the container comprises a dip tube for discharging purified liquid. To separate floating contaminants, such as mineral oil hydrocarbons, the dip tube can be immersed in a liquid in the container during use. In particular, the opening of the dip tube for discharging a purified liquid can be arranged below the floating contaminants.

Furthermore, a feed device for a separating apparatus is specified in the scope of the invention. The feed device comprises at least one liquid outlet through which a liquid to be purified can be fed to a container of the separating apparatus. At least one lower guide plate in use is arranged in the flow direction after the liquid outlet such that a liquid flowing out of the liquid outlet can be guided radially outwards through the lower guide plate, in particular in the direction of an inner wall of a container of a separating apparatus.

For the effect and advantages of the feed device according to the invention, reference is made to the explanations in connection with the separating apparatus.

The feed device is therefore disclosed and claimed both as part of the separating apparatus and on its own, i.e. independently of the separating apparatus. The refinements of the feed device explained above are also disclosed in connection with the feed device per se.

A further, concurrent aspect of the invention relates to a method for purifying a liquid in a separating apparatus which comprises a container and at least one feed device, wherein the container has at least one separating area and a settling and sludge collection chamber which is fluidically connected to the separating area to receive sediments to be separated and is arranged below the separating area during use, and wherein the feed device for feeding the liquid to be purified has at least one liquid outlet which opens into the separating area. According to the method, the liquid to be purified is fed to the container, wherein the liquid flowing out of the liquid outlet is guided radially outwards in the direction of the inner wall of the container by a lower guide plate arranged below the liquid outlet, so that separated sediments sink through a lower gap between the outer circumference of the lower guide plate and the inner wall of the container into the settling and sludge collection chamber, the purified liquid rises upwards and is then discharged from the container. Preferably, the purification of a liquid according to a method according to the invention takes place in a previously described separating apparatus.

The invention is explained in more detail in the following using an exemplary embodiment with reference to the appended schematic drawings. In the figures:

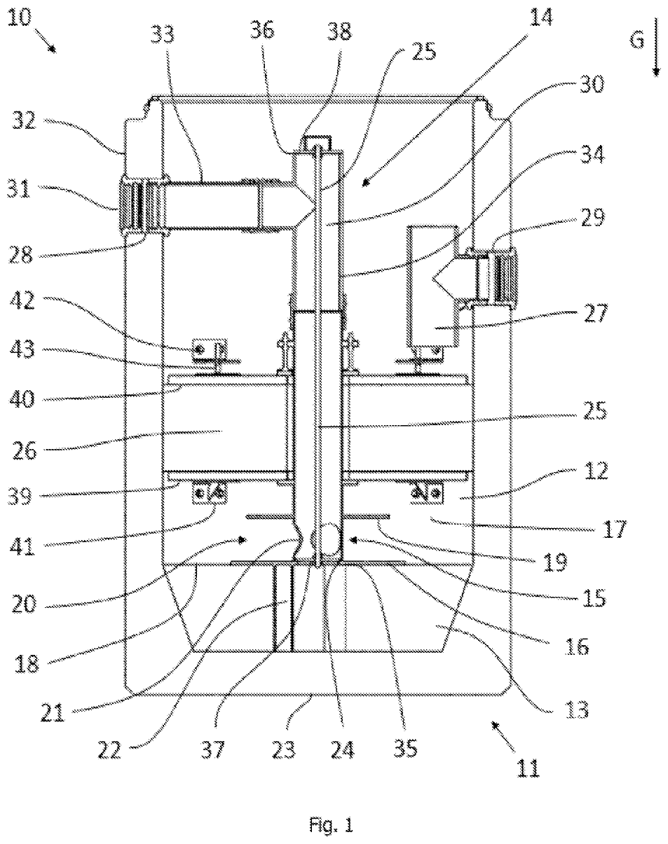

FIG. 1 shows a longitudinal section of a separating apparatus according to an exemplary embodiment of the invention;

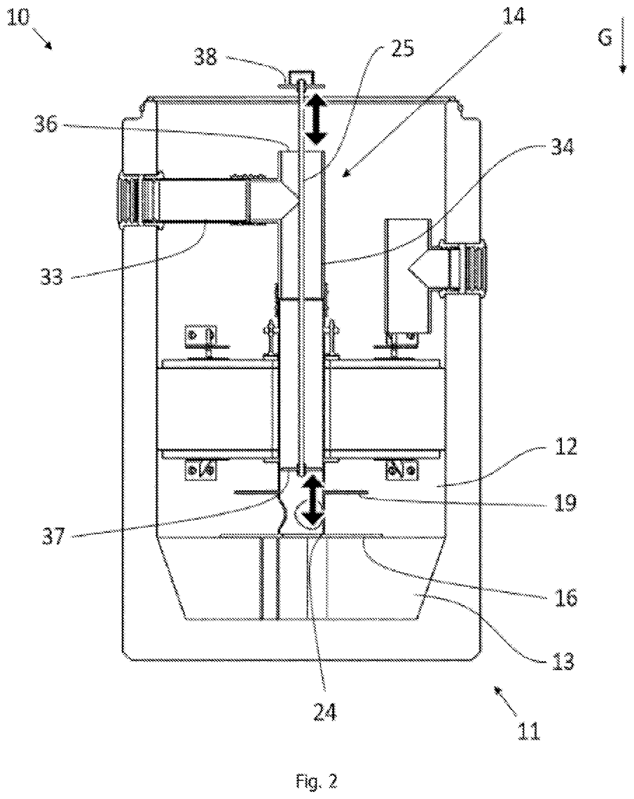

FIG. 2 shows a longitudinal section of the separator device from FIG. 1 with the passage opening of the lower guide plate open;

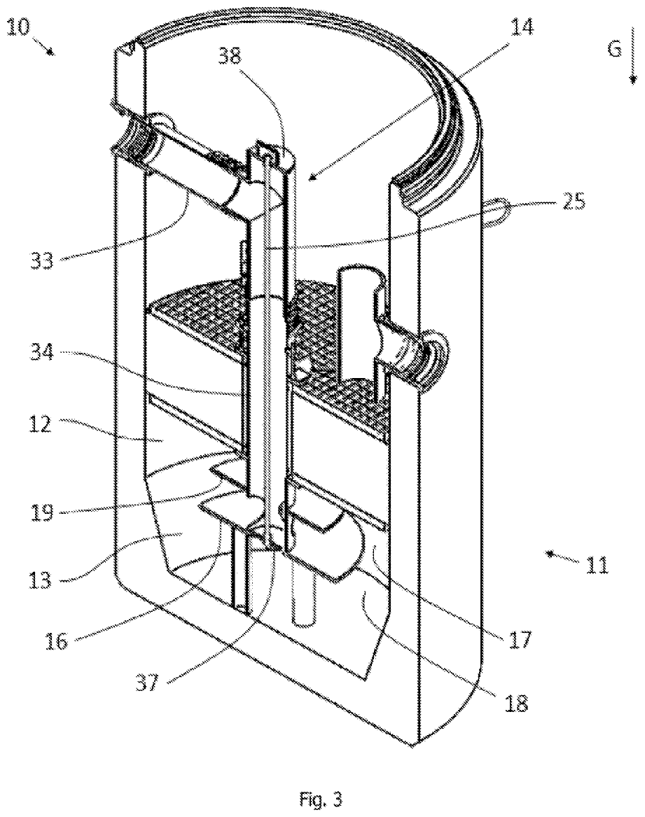

FIG. 3 shows a perspective view of the separating apparatus in the longitudinal section of FIG. 1;

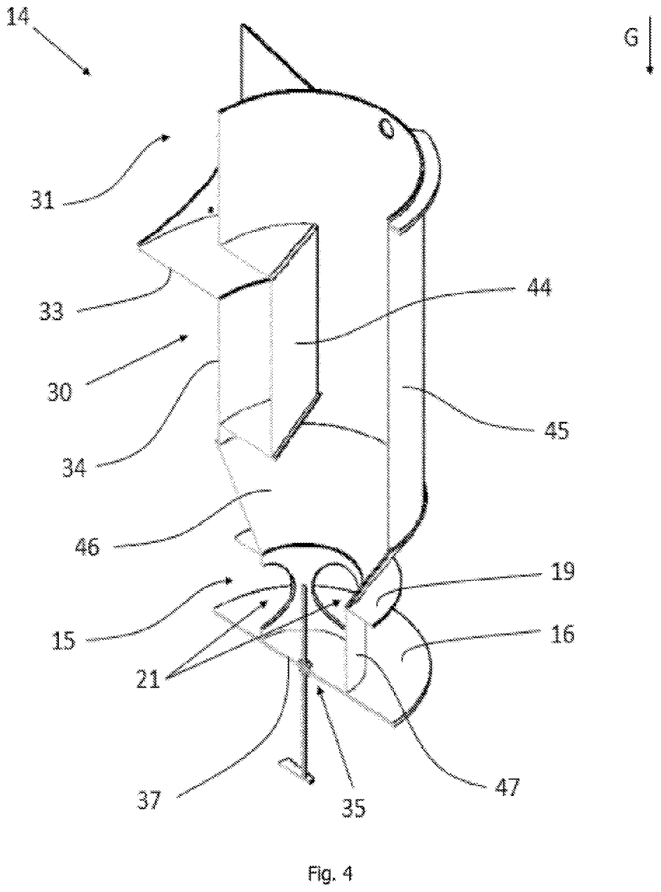

FIG. 4 shows a perspective view of a feed device in longitudinal section according to a further exemplary embodiment of the invention;

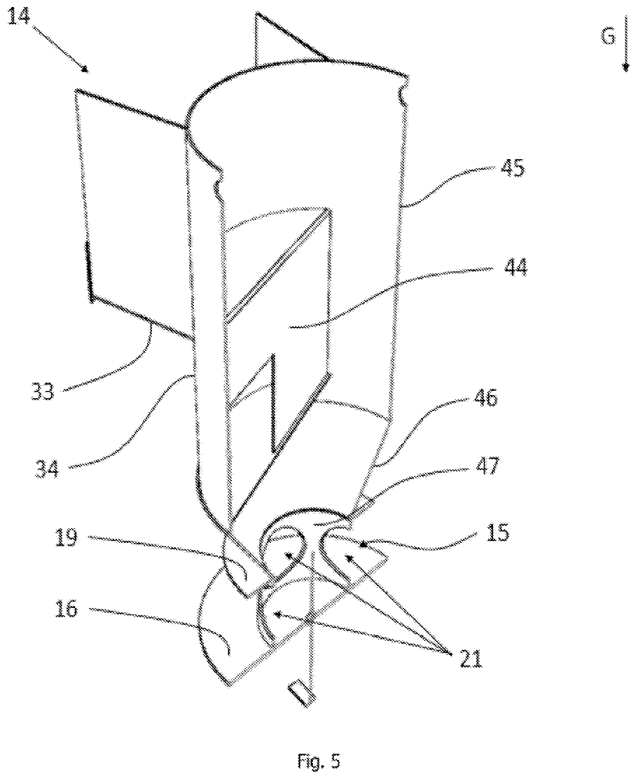

FIG. 5 shows a further perspective view of the feed device from FIG. 4 in longitudinal section;

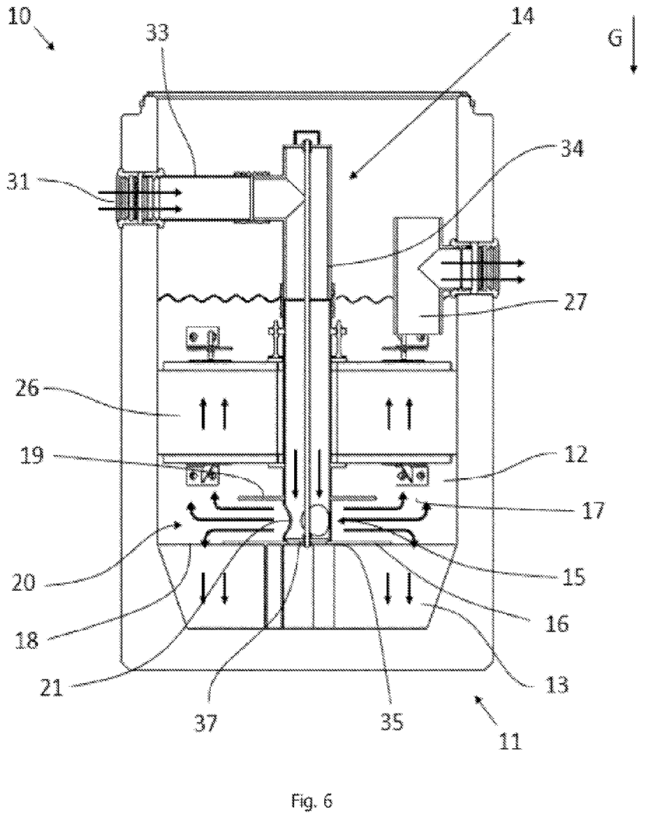

FIG. 6 shows a longitudinal section of the separating apparatus from FIG. 1 during the purifying of a liquid.

In the appended figures, a preferred exemplary embodiment of a separating apparatus 10 is shown. The separating apparatus 10 is used to purify a liquid and is used in particular for purifying rainwater in rainwater treatment plants. However, it is also possible to use the invention to purify other liquids.

The separating apparatus 10 shown in the appended figures is shown in the installed position, i.e. in use. Typically, the separating apparatus 10 forms a shaft during use. The gravity causing the separation is shown in the direction of gravity by the arrow G. The arrangement, in particular the height of the various areas and fittings of the separating apparatus 10, is related to the direction of gravity G, which acts as shown during use.

FIG. 1 shows a schematic longitudinal section through the separating apparatus 10 comprising a container 11. The container 11 is essentially designed as a hollow cylinder having a circular bottom 23 and a tubular side wall 32. Other geometries are possible. The direction of gravity G coincides with the longitudinal direction of the cylindrical container 11. In the illustrated embodiment variant, the container 11 is open at the top. The container 11 is closable by a lid (not shown). The side wall 32 comprises a feed opening 28 and a discharge opening 29. The feed opening 28 is arranged above the discharge opening 29. The feed opening 28 can be arranged at the same height as the discharge opening 29. The feed opening 28 is arranged substantially opposite to the discharge opening 29. The feed opening 28 and the discharge opening 29 can be freely positioned along the circumference of the container 11.

The container 11 has a separating area 12 and a settling and sludge collection chamber 13, wherein the settling and sludge collection chamber 13 is fluidically connected to the separating area 12 for receiving sediments to be separated and is arranged below the separating area 12. The settling and sludge collection chamber 13 is delimited at the bottom by the bottom 23 of the container 11.

The separating apparatus 10 according to FIG. 1 furthermore comprises a feed device 14 for feeding the liquid to be purified, having a liquid outlet 15 which opens into the separating area 12. The feed device 14 has a liquid inlet 31 which is fluidically connected to the outside of the container. The liquid inlet 31 is fluidically connected to the liquid outlet 15 via a liquid line 30.

The liquid line 30 has a substantially tubular geometry. For example, the cross section of the liquid line 30 is substantially circular. The liquid pipe 30 can also have other geometries.

The liquid line 30 has a substantially constant inner diameter. The liquid line 30 can have a substantially constant inner diameter in sections. The inner diameter can vary, in particular in sections.

The liquid line 30 is divided into a horizontal line section 33 and a vertical line section 34 with respect to the direction of gravity G. The end of the horizontal line section 33 forming the liquid inlet 31 is inserted into the feed opening 28 of the container 11. The other end of the horizontal line section 33 is connected to the vertical line section 34. The vertical line section 34 is arranged centrally in the cylindrical container. During use, it extends in the direction of gravity G. Other arrangements are possible.

The vertical line section 34 has an upper line opening 36 and a lower line opening 35. The upper line opening 36 is closed by an upper closure part 38 and the lower line opening 35 is closed by a lower closure part 37.

FIG. 1 shows that the liquid outlet 15 of the feed device 14 is provided in the lower part of the vertical line section 34. The liquid outlet 15 has three lateral outlet openings 21. In other words, the liquid outlet 15 is formed by three lateral outlet openings 21. The liquid outlet 15 can also have one or two outlet openings 21. The liquid outlet 15 can also have more than three lateral outlet openings. The outlet openings 21 are arranged evenly distributed in the circumferential direction of the feed device 14. In other words, the outlet openings 21 are arranged evenly distributed in the circumferential direction of the vertical line section 34. Consequently, the distances between the outlet openings 21 in the circumferential direction of the liquid line 30 are equal. In addition, the center points of the outlet openings 21 form a plane which is aligned substantially perpendicular to the longitudinal direction of the vertical line section 34. The outlet openings are formed substantially circular. Other geometries are possible.

The total opening area of the liquid outlet 15 is at least as large as the smallest inner cross-sectional area of the feed device 14 through which flow can occur. The total opening area of the outlet openings 21 is at least as large as the smallest inner cross-sectional area of the feed device 14 through which flow can occur. The liquid outlet 15 or the outlet openings 21 are thus designed such that they do not represent a taper of the cross-sectional area through which flow can occur for a liquid flowing through the liquid line 30.

The feed device 14 has a lower guide plate 16 between the settling and sludge collection chamber 13 and the separating area 12. In this way, the sediment and sludge collection chamber 13 and the separating area 12 are spatially separated from one another, wherein there is a fluid connection between the two areas 12, 13. The lower guide plate 16 is arranged below the liquid outlet 15, specifically below the lateral outlet openings 21, such that a liquid flowing out of the liquid outlet 15 can be guided radially outwards through the lower guide plate 16 in the direction of the inner wall of the container 11.

The feed device 14 has an upper guide plate 19 above the lower guide plate 16. The upper guide plate 19 and the lower guide plate 16 form an intermediate space 20 into which the liquid outlet 15 opens in such a way that a liquid flowing out of the liquid outlet 15 into the intermediate space 20 can be guided radially outwards through both guide plates. The lateral outlet openings 21 are arranged between the lower guide plate 16 and the upper guide plate 19, so that a liquid to be purified flows radially through the outlet openings 21 into the intermediate space 20.

A lower gap 18 is formed between the outer circumference of the lower guide plate 16 and the inner wall of the container 11. This allows separated sediments to sink into the settling and sludge collection chamber 13. Analogous to the lower guide plate 16, an upper gap 17 is formed between the outer circumference of the upper guide plate 19 and the inner wall of the container 11. In this way, liquid can rise upwards through the upper gap 17 after the separation of sediments.

The lower guide plate 16 can be formed as a substantially circular and flat disk. The lower guide plate 16 is substantially rotationally symmetrical. In the example according to FIG. 1, the lower guide plate 16 has a central passage opening 24 which is closable. The passage opening 24 is substantially circular. Accordingly, in this example, the lower guide plate 16 as such is substantially annular.

The lower guide plate 16 can have other geometries. Thus, the lower guide plate 16 can be designed to be closed, in particular substantially free of openings.

The lower guide plate 16 can also have edges and/or corners along its outer circumference. The lower guide plate 16 can also have a rotationally asymmetric geometry. A rotationally asymmetric geometry of the lower guide plate 16 can be advantageous if, for example, the liquid to be purified is to be guided through the lower guide plate 16 in a preferred radial direction.

The lower guide plate 16 is arranged at the lower end of the vertical line section 34. It is arranged centered with respect to the vertical line section 34 and perpendicular to the longitudinal direction. In other words, the lower guide plate 16 is aligned substantially coaxially with the vertical line section 34. The lower guide plate 16 spans a plane in which the circumference of the lower line opening 35 lies. The circumference of the passage opening 24 of the lower guide plate 16 corresponds to the circumference of the lower line opening 35. Thus, the circumference of the passage opening 24 coincides with the circumference of the lower line opening 35. The lower guide plate 16 is fastened along the circumference of its passage opening 24 to the outside of the vertical line section 34 or to the circumference of the lower line opening 35. The passage opening 24 of the lower guide plate 16 thus coincides with the lower line opening 35. In other words, the passage opening 24 corresponds to the lower line opening 35. The passage opening 24 of the lower guide plate 16 is thus closed by the lower closure part 37.

The upper guide plate 19 is substantially rotationally symmetrical. Specifically, the upper guide plate 19 is designed as a substantially circular and flat disk having a central passage opening. The passage opening is substantially circular. In other words, the upper guide plate 19 is substantially circular.

The upper guide plate 19 can have other geometries. Thus, the upper guide plate 19 can have edges and/or corners along its outer circumference.

The upper guide plate 19 can also have a rotationally asymmetric geometry. A rotationally asymmetric geometry of the upper guide plate 19 can be advantageous if, for example, the liquid to be purified is to be guided through the lower guide plate 16 and the upper guide plate 19 in a preferred radial direction.

The upper guide plate 19 is arranged above the liquid outlet 15, specifically above the lateral outlet openings 21. It is arranged centered with respect to the vertical line section 34 and perpendicular to the longitudinal direction. In other words, the upper guide plate 19 is aligned substantially coaxially with the vertical line section 34. The vertical line section 34 extends through the passage opening of the upper guide plate 19. The upper guide plate 19 is in contact with the outside of the vertical line section 34 along the circumference of its passage opening. Thus, the circumference of the passage opening of the upper guide plate 19 in the contact area corresponds to the outer circumference of the vertical line section 34. The upper guide plate 19 is fastened to the outside of the vertical line section 34 along the circumference of its passage opening.

The upper guide plate 19 is arranged substantially parallel to the lower guide plate 16. In other words, the upper guide plate 19 is arranged substantially coaxially to the lower guide plate 16.

Both guide plates 16, 19 delimit the intermediate space 20 in the vertical direction. The intermediate space 20 thus has a constant height. The vertical line section 34 extends from the passage opening of the upper guide plate through the intermediate space to the passage opening 24 of the lower guide plate 16. The liquid outlet 15, i.e. the lateral outlet openings 21, is arranged between the two guide plates 16, 19. The liquid outlet 15 thus fluidically connects the interior of the vertical line section 34 to the intermediate space 20. The outlet openings 21 are arranged substantially perpendicular to the lower guide plate 16 or to the upper guide plate 19.

The lower gap 18 is substantially radially circumferential. In other words, the lower gap 18 is annular. The lower gap 18 has a substantially constant radial width. Analogously, the upper gap 17 is substantially radially circumferential. In other words, the upper gap 17 is annular. The upper gap 17 has a substantially constant radial width.

The area of the lower guide plate 16 is larger than the area of the upper guide plate 19. In other words, the lower guide plate 16 has a larger outer diameter than the upper guide plate 19. Conversely, the lower gap 18 has a smaller inner diameter than the upper gap 17. Thus, the width of the lower gap 18 is smaller than the width of the upper gap 17.

The feed device 14 furthermore comprises three support feet 22 which are arranged on the lower guide plate 16 and support the feed device on the bottom 23 of the container 11. Another support of the feed device 14 is possible. The support feet 22 are thus located in the settling and sludge collection chamber 13 and support the lower guide plate 16 like a column above the settling and sludge collection chamber 13. The support feet 22 are arranged vertically and, in a top view, are evenly distributed along a circle centered on the longitudinal direction of the vertical line section 34. In other words, the three support feet 22 form an isosceles triangle in a top view, the triangle center of which coincides with the longitudinal axis of the vertical line section 34.

Above the lower guide plate 16, a treatment stage 26, in particular a substrate filter stage for the filtration and adsorption of filterable substances and dissolved contaminants, is provided. The treatment stage 26 is arranged above the upper guide plate 19. The treatment stage 26 is arranged between a lower protective grating 39 and an upper protective grating 40. The lower protective grating 39 rests on lower supports 41 which are fastened on the vertical line section 34 and on the inner wall of the container 11. The upper protective grating 39 is fixed on top via upper supports 42 which are fastened on the vertical line section 34 and on the inner wall of the container 11. The treatment stage 26 can be adjusted in height by means of fasteners 43, such as threaded rods, which are arranged between the upper protective grating 39 and the upper supports 42.

The treatment stage 26 comprises removable segments. By removing or adding individual segments, handling when installing and/or removing the treatment stage is simplified. The segments are substantially formed as circular segments.

The distance between the upper guide plate 19 and the lower protective grating 39 is at least 100 mm.

To discharge purified liquid, the container 11 also comprises a dip tube 27. The dip tube 27 comprises a vertical tube piece which can be immersed in a liquid in the container 11 during use. The vertical tube piece opens into a horizontal tube piece which is inserted into the outlet opening 29 of the container 11 and thus establishes a fluidic connection between the interior and the exterior of the container 11.

In FIG. 2, a further longitudinal section of the separating apparatus 10 is shown, wherein the passage opening 24 of the lower guide plate 16 is open. In other words, the lower line opening 35 is open. The passage opening 24 or the lower line opening 35 connects the settling and sludge collection chamber 13 to the interior of the vertical line section 34, so that separated sediments are removable from the settling and sludge collection chamber 13 through the vertical line section 34. In order to prevent the liquid to be purified from flowing into the settling and sludge collection chamber 13 during operation, the passage opening 24 is closable by means of an actuating device 25 which can be led through the vertical line section 34. For this purpose, the lower closure part 37 is attached to the lower end of the actuating device 25. The upper closure part 38 is mounted at the opposite end of the actuating device 25. A handle is also arranged on the outside of the upper closure part 38. In this way, simultaneously by means of the actuating device 25, the passage opening 24 or the lower line opening 35 can be opened and closed by the lower closure part 37 and the upper line end 36 of the vertical line section 34 can be opened and closed by the upper closure part 38 (indicated by vertical arrows).

FIG. 3 shows a perspective view of the separating apparatus 10. The cylinder shape of the container 11 and the annular shape of the lower guide plate 16 and the upper guide plate 19 are clearly visible. In addition, the substantially radially circumferential and annular shape of the gap 17 and the gap 18 is visible. Furthermore, it is made clear that the vertical line section 34 is arranged coaxially to the longitudinal axis of the cylindrical container 11. In addition, it can be seen that the horizontal line section 33 and the vertical line section 34 are arranged relative to one another such that the respective longitudinal axes intersect at a substantially right angle. In addition, the two closure parts 37, 38 are clearly visible, which are arranged in their closed position and are connected to one another via the actuating device 25.

FIG. 4 shows a perspective view of a feed device 14 in longitudinal section according to a further exemplary embodiment of the invention; The feed device 14 comprises a liquid line 30 which fluidically connects a liquid inlet 31 to a liquid outlet 15. The liquid line 30 is divided into a horizontal line section 33 and a vertical line section 34.

The horizontal line section 33 has a substantially rectangular cross section, wherein the width of the cross section decreases in the flow direction. The horizontal line section 33 becomes narrower in the flow direction. The horizontal line section 33 opens into the vertical line section 33.

The orifice of the horizontal line section 33 into the vertical line section 34 is arranged in the upper area of the vertical line section 34. The vertical line section 33 comprises a deflection device 44 behind the orifice in the flow direction in order to introduce the liquid flowing from the horizontal line section 33 into the vertical line section 34 tangentially into the vertical line section 33.

The vertical line section 34 is divided into an upper subsection 45, a middle subsection 46, and a lower subsection 47, wherein the sections are arranged one below another. The upper subsection 45 has a substantially circular cross section having a substantially constant inner diameter. The upper end of the middle subsection 46 adjoins the lower end of the upper subsection 45. The middle subsection 46 therefore has an inner diameter at the upper end which substantially corresponds to the inner diameter of the upper subsection 45. The middle subsection 46 has a substantially funnel-shaped geometry. The inner diameter of the middle subsection 46 decreases substantially continuously in the flow direction. The geometry of the middle subsection 46 forms a taper of the cross-sectional area through which flow can occur in the flow direction. The upper end of the lower subsection 47 adjoins the lower end of the middle subsection 46. The lower subsection 47 has a substantially circular cross section having a substantially constant inner diameter. The middle subsection 46 therefore has an inner diameter at the lower end which substantially corresponds to the inner diameter of the lower subsection 47.

The lower subsection 47 has at its lower end a lower line opening 35 which is closed by a lower closure part 37. At the lower end of the lower subsection 47, a lower guide plate 16 is arranged substantially coaxially to the vertical line section 34. The lower guide plate 16 has a substantially circular geometry having a central passage opening 24. The passage opening 24 of the lower guide plate 16 substantially corresponds to the lower line opening 35, so that the passage opening 24 is also closed by the lower closure part 37.

An upper guide plate 19 is arranged above the lower guide plate 16. The upper guide plate 19 has a substantially annular geometry having a central passage opening. The upper guide plate 19 is arranged substantially coaxially to the vertical line section 34 and thus substantially parallel to the lower guide plate 16. The outer diameter of the upper guide plate 19 is smaller than the outer diameter of the lower guide plate 16. The upper guide plate 19 is connected to the outside of the vertical line section 34 along the circumference of its passage opening. The upper guide plate 19 is arranged between the middle subsection 46 and the lower subsection 47.

Both guide plates 16, 19 delimit an intermediate space 20 in the vertical direction. The intermediate space 20 thus has a constant height. The lower subsection 47 extends from the passage opening of the upper guide plate through the intermediate space 20 to the passage opening 24 of the lower guide plate 16.

The liquid outlet 15 is arranged between the two guide plates 16, 19. The liquid outlet 15 comprises three lateral outlet openings 21. The liquid outlet 15 is formed by the outlet openings 21. The outlet openings 21 fluidically connect the interior of the lower subsection 47 to the intermediate space 20.

The outlet openings 21 are arranged unevenly distributed in the circumferential direction of the feed device 14, specifically in the circumferential direction of the lower subsection 47. Two of the three outlet openings 21 are aligned substantially opposite to one another, wherein the third outlet opening 21 is arranged substantially therebetween in the circumferential direction. Thus, the lower subsection 47 is closed relative to the third outlet opening 21.

FIG. 5 shows a further perspective view of the feed device from FIG. 4 in longitudinal section. The substantially rectangular cross section of the horizontal line section 33 is visible. The deflection device 44 can also be seen. In addition, the arrangement of the three lateral outlet openings 21 in the lower subsection 37 is made clear.

FIG. 6 shows a longitudinal section of the separating apparatus 10 from FIG. 1 in operation, i.e. during the purifying of a liquid.

In this case, a liquid to be purified is fed to the container 11, wherein the liquid to be purified flows starting from the liquid inlet 31 of the feed device 14 through the horizontal line section 33 and the vertical line section 34 in the direction of the liquid outlet 15. The liquid outlet 15 comprises lateral outlet openings 21 so that the liquid to be purified flows through the outlet openings 21 into the separating area 12. The liquid to be purified flows from the lateral outlet openings 21 through the intermediate space 20 arranged in the separating area 12, wherein the liquid to be purified is guided radially outwards through both guide plates 16, 19 in the direction of the inner wall of the container 11. This ensures that the liquid to be purified is evenly distributed. Separated sediments then sink through the lower gap 18 into the settling and sludge collection chamber 13. Since the lower guide plate 16 shields a large part of the settling and sludge collection chamber 13 from flows in the separating area 12, remobilization of separated sediments in the settling and sludge collection chamber is reduced. The sediment-poor liquid then rises through the upper gap 17 and traverses the treatment stage 26, wherein contaminants, in particular finely distributed and dissolved contaminants, such as heavy metals or filterable substances, are additionally removed. Floating impurities, such as mineral oil hydrocarbons, float on the liquid surface so that the purified liquid is located underneath. The lower opening of the dip tube 27 is below the liquid surface or the floating impurities, so that the purified liquid is removed from the container through the dip tube 27.

### LIST OF REFERENCE SIGNS

10 separating apparatus
11 container
12 separating area
13 settling and sludge collection chamber
14 feed device
15 liquid outlet
16 lower guide plate
17 upper gap
18 lower gap
19 upper guide plate
20 intermediate space
21 lateral outlet openings
22 support foot
23 bottom of the container
24 passage opening of the lower guide plate
25 actuating device
26 treatment stage
27 dip tube
28 feed opening
29 discharge opening
30 liquid line
31 liquid inlet
32 side wall of the container
33 horizontal line section
34 vertical line section
35 lower line opening
36 upper line opening
37 lower closure part
38 upper closure part
39 lower protective grating
40 upper protective grating
41 lower supports
42 upper supports
43 fastening means
44 deflection device
45 upper subsection
46 middle subsection
47 lower subsection
G direction of gravity

1. A separating apparatus (10) for purifying a liquid, comprising
a container (11) having at least one separating area (12) and a settling and sludge collection chamber (13), wherein the settling and sludge collection chamber (13) is fluidically connected to the separating area (12) for receiving sediments to be separated and is arranged below the separating area (12), and
at least one feed device (14) for feeding the liquid to be purified having at least one liquid outlet (15) which opens into the separating area (12),
wherein the feed device (14) has at least one lower guide plate (16) between the settling and sludge collection space (13) and the separating area (12), wherein the lower guide plate (16) is arranged during use below the liquid outlet (15) such that a liquid flowing out of the liquid outlet (15) can be guided radially outwards through the lower guide plate (16) in the direction of the inner wall of the container (11), wherein a lower gap (18) is formed between the outer circumference of the lower guide plate (16) and the inner wall of the container (11).

2. The separating apparatus (10) according to claim 1,
wherein the feed device (14) has an upper guide plate (19) which, during use, is arranged above the lower guide plate (16), wherein the upper guide plate (19) and the lower guide plate (16) form an intermediate space (20) into which the liquid outlet (15) opens such that a liquid flowing from the liquid outlet (15) into the intermediate space (20) can be guided radially outwards through both guide plates.

3. The separating apparatus (10) according to claim 2,
wherein an area of the lower guide plate (16) substantially corresponds to or is greater than the area of the upper guide plate.

4. The separating apparatus (10) according to claim 1,
wherein a total opening area of the liquid outlet (15) substantially corresponds to or is greater than the smallest inner cross-sectional area of the feed device (14) through which flow can occur.

5. The separating apparatus (10) according to claim 1,
wherein the liquid outlet (15) has multiple lateral outlet openings (21).

6. The separating apparatus (10) according to claim 5,
wherein the lateral outlet openings (21) are arranged distributed in the circumferential direction of the feed device (14).

7. The separating apparatus (10) according to claim 1,
wherein the feed device (14) has at least one support foot (22) which is arranged on the lower guide plate (16) and, during use, supports the feed device (14) on a bottom (23) of the container.

8. The separating apparatus (10) according to claim 1,
wherein the lower guide plate (16) has a passage opening (24) which is closable by means of an actuating device (25) which can be led through the feed device (14), wherein the passage opening (24) connects the settling and sludge collection chamber (13) to the interior of the feed device (14) in such a way that separated sediments are removable from the settling and sludge collection chamber (13) through the interior of the feed device (14).

9. The separating apparatus (10) according to claim 1,
wherein a treatment stage (26) is arranged above the lower guide plate (16).

10. The separating apparatus (10) according to claim 9,
wherein the treatment stage (26) comprises removable segments.

11. The separating apparatus (10) according to claim 9,
wherein the treatment stage (26) is adjustable in its height.

12. The separating apparatus (10) according to claim 1,
wherein the container (11) comprises a dip tube (27) for discharging purified liquid.

13. A feed device (14) for a separating apparatus (10) according to claim 1, having at least one liquid outlet (15) through which a liquid to be purified can be fed to a container (11) of the separating apparatus (10),
wherein at least one lower guide plate (16), during use, is arranged downstream of the liquid outlet (15) in the flow direction such that a liquid flowing out of the liquid outlet (15) can be guided radially outwards through the lower guide plate (16) in the direction of an inner wall of a container (11) of a separating apparatus (10).

14. A method for purifying a liquid in a separating apparatus (10) according to claim 1, which comprises a container (11) and at least one feed device (14), wherein
the container (11) has at least one separating area (12) and a settling and sludge collection chamber (13), wherein the settling and sludge collection chamber (13) is fluidically connected to the separating area (12) for receiving sediments to be separated and is arranged below the separating area (12), and
the feed device (14) for feeding the liquid to be purified has at least one liquid outlet (15) which opens into the separating area (12),
wherein the liquid to be purified is fed to the container (11), wherein the liquid flowing out of the liquid outlet (15) is guided radially outwards in the direction of the inner wall of the container (11) by a lower guide plate (16) arranged below the liquid outlet (15), so that separated sediments sink through a lower gap (18) between the outer circumference of the lower guide plate (16) and the inner wall of the container (11) into the settling and sludge collection chamber (13), the purified liquid rises upwards and is then discharged from the container (11).
